(19) United States
(12) Patent Application Publication
(10) Pub. No.: US 2012/0319486 A1
(43) Pub. Date: Dec. 20, 2012

(54) BATTERY BACKUP SYSTEM AND ASSOCIATED METHOD

(76) Inventor: James Allen Polasek, Spring Branch, TX (US)

(21) Appl. No.: 13/163,195

(22) Filed: Jun. 17, 2011

(51) Int. Cl. H02J 9/06; H02J 7/35; H02J 7/00

(52) U.S. Cl. 307/65; 320/103; 320/101

(57) ABSTRACT

The invention is related to a battery backup system comprising a power cell array, a controller, and a power inverter. The power cell array may include power cells and a charger to provide electrical power to the power cells. The power cells may include a battery for storing and discharging electrical power, a control input, and a feedback output connected to the controller. The controller may control the operational state of the power cells between a charge state and a power state. The controller may also include a feedback input, and a control output connected to the power cells. The power inverter may convert electrical power discharged from the power cell array to drive the charger and a load.

### FIELD OF THE INVENTION

The present invention relates to the fields of battery backup systems and, more specifically, to battery backup systems that may cycle an operational state of power cells to operate with high efficiency.

### BACKGROUND OF THE INVENTION

Electrical power is essential to perform many daily tasks in a modernized society. Most, if not all, offices and homes in the United States are connected to a source of electrical power. These homes and offices may draw electrical power from the power grid to power computers for productivity, televisions for entertainment, heaters or air conditioners for comfort, and an endless number of other electric based devices.

Although the electrical infrastructure in a modern society may operate with a majority of up-time, the occasional power outage may still occur. In the event that a power outage does occur, a person may wish not to endure the loss of productivity or comfort that may accompany a power outage. As a result, there exists a need to store electrical power to drive electrical devices in such emergency situations.

There have been proposed solutions to store electrical power, which may include storing the electrical power in an array of batteries. However, many battery arrays are unmanaged, and may be limited to the efficiency of the weakest battery.

There have been modified attempts of the proposed solution included above, in which electrical power may be alternately discharged from multiple batteries. An example of such a proposed solution may be found in U.S. Pat. No. 6,924,567 to Killian, et al., which discusses the use of mechanical and electrical switches to alternate which battery is delivering power for predetermined durations. This proposed solution may alternate the batteries between a power and a charge state, but it may not take into account the present state of the battery charge and capacity, thus leading to inefficient operation.

Accordingly, there exists a need for a battery backup system that may selectively control an array of batteries to intelligently supply electrical power in emergency situations. There further exists a need for a battery backup system that may charge one or more battery while drawing power from other batteries.

### SUMMARY OF THE INVENTION

The battery backup system of the present invention may advantageously control an array of power cells, which may further include batteries, to intelligently drive a supply power in an emergency situation. The present invention may also advantageously provide a battery backup system to charge one or more power cells, which may include one or more battery, while drawing electrical power from other power cells. The system according to the present invention may further advantageously provide enhanced life to batteries in a battery backup system. The system according to the present invention may still further advantageously provide enhanced reliability of the backup battery system.

With the foregoing in mind, the present invention advantageously provides a battery backup system comprising a power cell array that includes power cells and a charger to provide electrical power to be stored in the power cells. Each of the power cells may comprise a battery to store and discharge electrical power, a control input to control a state of the power cells, and a feedback output to provide feedback signals.

The battery backup system may also include a controller to control operation of the power cell array that includes a feedback input to receive the feedback signals relating to a status of each of the power cells. The controller may also include a control output to control the state of the power cells. The battery backup system may further include a power inverter to convert the electrical power discharged by the power cell array.

The state of each of the power cells may include a power state defined by the power cells discharging the electrical power, and a charge state defined by the power cells receiving and storing the electrical power. The power cells may be switchable between the power state and the charge state, and a ratio of the power cells in the power state to the power cells in the charging state is preferably at least two to one.

The power cell array may output the electrical power as direct current electrical power. The power inverter may convert the direct current electrical power, into alternating current electrical power to be used by a load. The charger may receive the electrical power as alternating current electrical power, and may convert the current electrical power into direct current electrical power to store in the battery.

The controller may operate each of the power cells in the power state until a threshold charge level is sensed. The controller may switch the power cells that are below the threshold charge level into the charge state, and may correspondingly switch the power cells that are above the threshold charge level into the power state. The power cells may further include an idle state defined by substantially maintaining the electrical power in the power cells.

The system may be operational in a non-emergency operation mode and an emergency operation mode. The non-emergency operation mode may be defined as the load not drawing the electrical power from the power cell array, and the emergency operation mode may be defined as the load drawing the electrical power from the power cell array. The load may provide electrical power to the power cell array during the non-emergency operation. The power inverter may be a pure sine wave inverter, and the controller may include a microprocessor. The power cell may also further include a servomechanism. The load may be a solar panel, a windmill or a hydro-electric generator.

A method aspect of the present invention is for storing and discharging electrical power in the battery backup system. The method may include controlling a state of each of the power cells by transmitting a control signal from the controller to each of the power cell. The method may also include controlling each of the power cells in the power state to discharge the electrical power and controlling each of the power cells in the charge state to receive and store the electrical power. The method may further include providing a feedback signal from each of the power cells to the controller relating to a status of each of the power cells. The method may still further include transmitting electrical power from the power cell array by discharging the electrical power from each of the power cells in the power state to the power inverter, and converting the electrical power discharged by the power cell array. The method may still further include storing electrical power in the power cell array by receiving the electrical power by the power cell, and converting the electrical power received to store in the power cell array.

### BRIEF DESCRIPTION OF THE DRAWINGS

FIG. 1 is a block diagram of a battery backup system according to an embodiment of the present invention.

FIG. 2 is a schematic block diagram of the battery backup system illustrated in FIG. 1.

FIG. 3 is a block diagram of a power cell of the battery backup system illustrated in FIG. 1.

FIG. 4 is a block diagram of a controller of the battery backup system illustrated in FIG. 1.

FIG. 5 is an illustration depicting a flow of electrical power according to an embodiment of the battery backup system according to the present invention.

FIG. 6 is flow chart depicting operation of the battery backup system according to an embodiment of the present invention.

### DETAILED DESCRIPTION OF THE PREFERRED EMBODIMENT

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Additionally, in the following detailed description, reference may be made to the storage and delivery of electrical power from a battery backup system. A person of skill in the art will appreciate that the use of batteries within this disclosure is not intended to be limited to the any specific form of electrical power storage medium, and should be read to apply to power supply media in general. Accordingly, skilled artisans should not view the following disclosure as limited to the any particular power supply medium, and should read the following disclosure broadly with respect to the same.

The disclosure of the battery backup system 10 of the present invention below may be described to supply power to a home or office during emergency situations. A person of skill in the art will appreciate that the battery backup system 10 described below may be used in a plethora of additional applications, and should not be limited to emergency power supply scenarios.

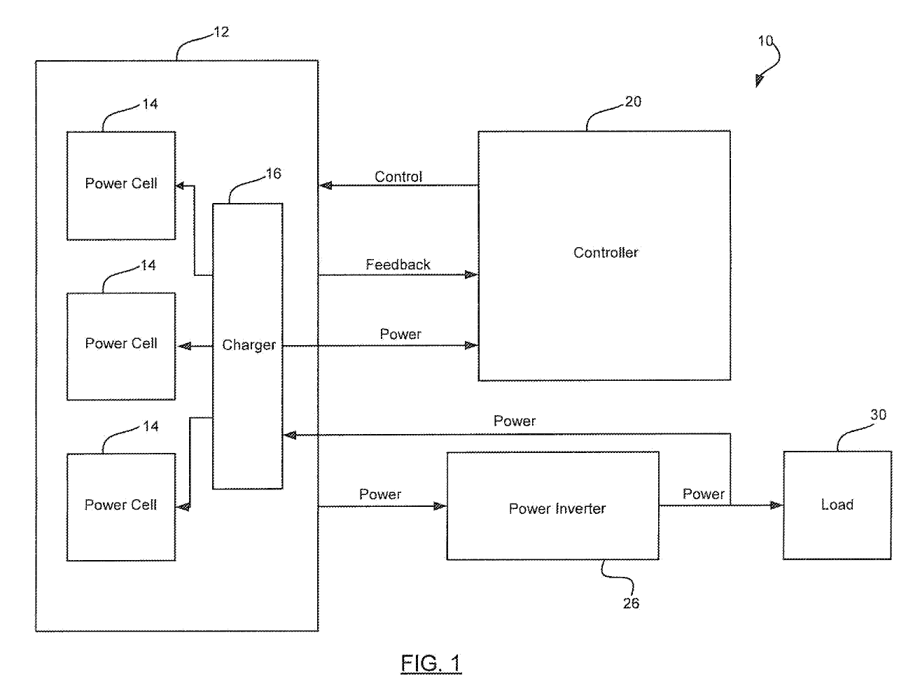

Referring now to FIGS. 1-6, a battery backup system 10 according to the present invention in now described in greater detail. Throughout this disclosure, the battery backup system 10 may also be referred as a system, device, or the invention. Alternate references of the battery backup system 10 in this disclosure are not meant to be limiting in any way.

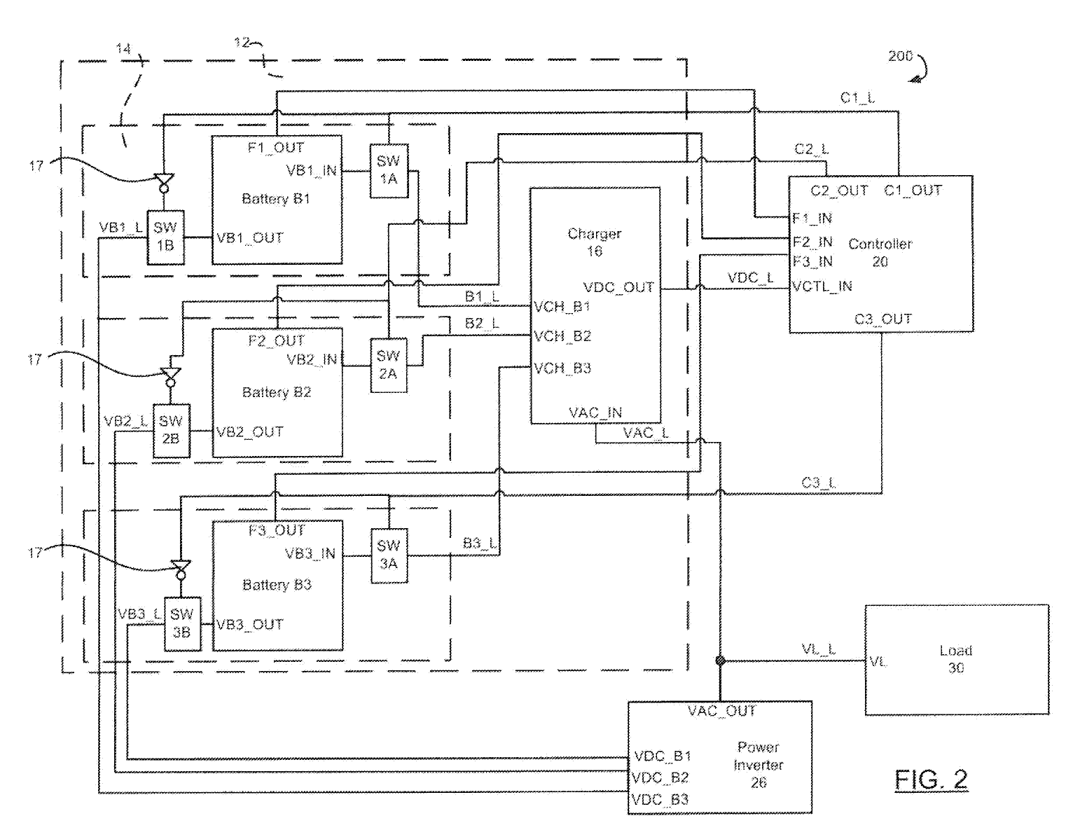

FIG. 1 illustrates a block diagram of the battery backup system 10 according to an embodiment of the present invention. FIG. 2 illustrates a schematic diagram 200 of the connective structure of an embodiment of the battery backup system 10 of the present invention.

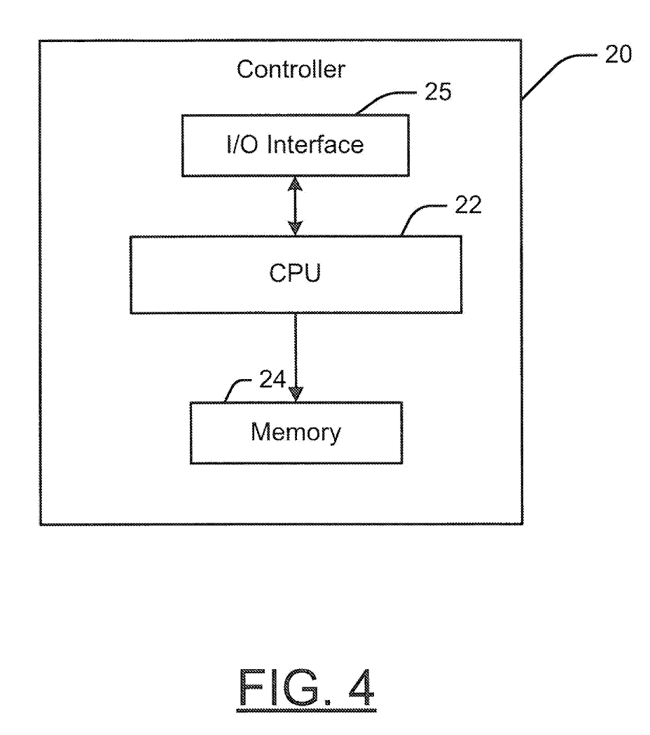

The battery backup system 10 of the present invention may include a controller 20, a power cell array 12, and a power inverter 26. The power cell array 12 may additionally include a plurality of power cells 14 and one or more chargers 16. The controller 20 may further include a central processing unit 22 (CPU), memory 24, and an input/output (I/O) interface 25, as shown in FIG. 4. The power inverter 26 included in the battery backup system 10 of the present invention may be connected to a load 30, which will be understood by a person of skill in the art to include any electrical device that may consume or supply electrical power.

The controller 20 may be connected to the power cell array 12 to control the operational state of the power cells 14 and receive feedback therefrom. The power cells 14 included, in the power cell array 12 may be alternated between a power state and a charge state, and may also provide a feedback signal to the controller 20 regarding the current operational state of the power cell 14.

A charger 16 may be connected to the power inverter 26 to receive electrical power, and may provide electrical power to the controller 20 and the power cells 14 in the charge state. A load 30 may be connected to the power inverter 26 and the charger 16, which may consume the electrical power delivered by the power inverter 26. The load 30 may also deliver electrical power to the charger 16. The power inverter 26 may be connected to the power cell array 12, from which the power inverter 26 may draw power.

Referring now to the schematic 200 of FIG. 2, the connective structure of the battery backup system 10 of the present invention will now be discussed in more detail. A person of skill in the art will appreciate that the schematic 200 presented in FIG. 2 is provided as an illustrative embodiment of the battery backup system 10 of the present invention, and is not intended to limit the present invention in any way. Skilled artisans will also appreciate, after having the benefit of this disclosure, additional embodiments to be included within the scope and spirit of the present invention.

The controller 20 may be connected to the charger 16 to receive electrical power. This connection is illustrated in the schematic 200 as the line VDC_L running between VDC_OUT output of the charger 16 and the VCTL_IN input of the controller 20. The connection may also provide electrical power to operate the controller 20. More specifically, the charger 16 may provide direct current electrical power to operate the controller 20.

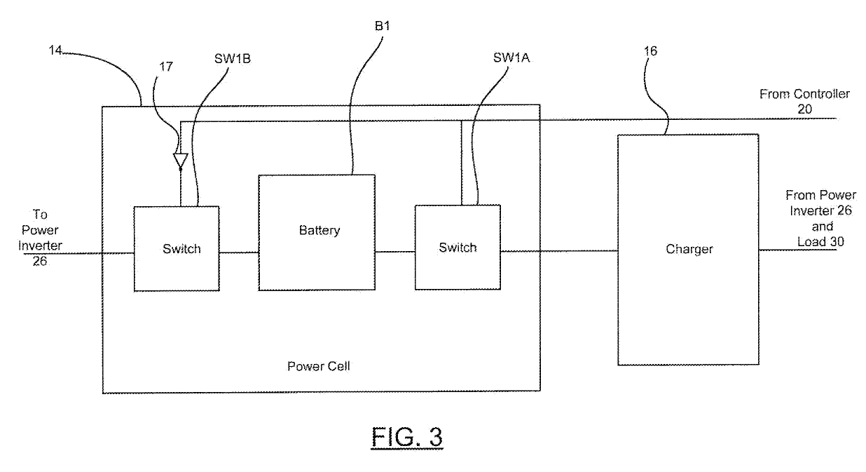

The controller 20 may additionally connect to the power cell array 12, additionally illustrated in FIG. 3, to control the operation of the individual power cells 14. Each power cell 14 may include, for example, a battery (such as batteries B1-B3 of schematic 200) and one or more switch (such as SW1A-SW3A, SW1B-SW3B of schematic 200). In the present embodiment, provided herein for clarity and without limitation, each power cell 14 may include one battery and two switches. Also for clarity in the present example, the elements of the first power cell 14 will be discussed in the connections described below. A person of skill in the art will appreciate that the elements included within additional power cells 14 may be substantially similar to the elements included within the first power cell 14. Accordingly, although the following disclosure may describe the components of the first power cell 14, a person of skill in the art should appreciate that the connective structure of the first power cell 14 may apply to any additional power cells 14.

The controller 20 may include feedback input connections to one or more batteries B1 included within each power cell 14, through which the controller 20 may determine the operational status of the battery B1, and therefore the power cell 14. The operational status may include feedback information such as, but not limited to, the level of charge present in the battery B1. As illustrated in the schematic 200, the battery B1 may include an output connection F1_OUT, which may connect to The feedback input F1_IN of the control cell 18. As discussed above, feedback information may be transmitted to the controller 20 using this connection. A person of skill in the art will appreciate substantially similar connections for the additional power cells 14.

Additional connections may be included between the power cell 14 and the controller 20 according to this embodiment of the battery backup system 10. The controller 20 may include a control output connection to the switches of the power cell 14, through which it may control the operation of the power cell 14 between the power state and the charge state. This control output connection may be represented as the line C1_L between C1_OUT of the controller 20 and the subsequent connection to SW1A and SW1B. A “not” logical gate 17 may be located between the C1_OUT output of the controller 20 and one of the switches SW1A or SW1B so that the switches may receive control signals from the controller 20 that are opposite each other. For example, if the controller 20 transmits a high signal, otherwise known as a logical “1,” a first switch SW1A may receive the high signal and operate with the switch SW1A opened. The same high signal, which may be transmitted by the controller 20, may be inverted by the “not” gate 17, located between the controller 20 control output C1_OUT and the second switch SW1B. The “not” gate 17 may invert the high signal into a low signal, otherwise known as a logical “0.” This low signal may cause, the second switch SW1B to operate in the closed state. A person of skill in the art will appreciate similar connections for the additional power cells 14.

As a power cell 14 may operate in the charge state, it may receive electrical power from the charger 16. This receipt of electrical power may allow the battery B1 to be charged. The electrical power connection may be illustrated in the schematic 200 as the line B1_L connected between the charger 16, at VCH_B1 output, and the first switch of a power cell 14, such as SW1A. When the first switch SW1A is closed by the controller 20, the electrical power may flow from the charger 16 to the battery B1 to charge the battery B1. As discussed below, the “not” logical gate 17 may cause the second switch SW1B to be opened, preventing electrical power from being drawn from the battery B1 while operating in the charge state. A person of skill in the art will appreciate substantially similar connections for the additional power cells 14.

As a power cell 14 may operate in the power state, electrical power may be drawn the battery B1 to power a power inverter 26. The electrical power connection may be illustrated in the schematic 200 as the line VB1_L connected between the second switch of the power cell 14, such as between switch SW1B and the input VDC_B1 of the power inverter 26. When the second switch SW1B is closed by the controller 20, the electrical power may flow from the battery to the power inverter 26. The power inverter 26 may then provide electrical power to a load 30 or additional elements of the battery backup system 10 of the present invention.

As discussed below, as the controller 20 may close the second switch SW1B, the “not” logical gate 17 may result in the first switch SW1A to be opened. The opening of the first switch SW1A may prevent electrical power from being drawn from the charger 16 while the power cell 14 operates in the power state. A person of skill in the art will appreciate substantially similar connections for the additional power cells 14.

The power inverter 26 may receive direct current (DC) electrical power from the power cell array 12. The power inverter 26 may also invert the DC electrical power into alternating current (AC) electrical power. The AC electrical power may be used to drive a load 30. The AC electrical power may also drive the charger 16, which has been described in greater detail above.

Alternately, as will be understood by a person of skill in the art, the DC electrical power drawn from the power cell array 12 may be used to drive a DC load 30. Directly driving a DC load 30 may allow the DC electrical power drawn from the power cell array 12 to bypass the power inversion performed by the power inverter 26. In this embodiment, the voltage and/or current characteristics of the DC electrical power, drawn from the power cell array 12, may be conditioned prior to driving a DC load 30, as may be required by the respective DC load 30.

The power inverter 26 may receive electrical power at its input VDC_B1 from the VB1_OUT output of the battery in a power cell 14, which may pass through a closed switch SW1B. A person of skill in the art will appreciate substantially similar connections for the additional power cells 14. The power inverter 26 may invert the DC electrical power received from the power cell array 12 into an AC electrical power, which may be outputted to the charger 16 and/or load 30. The power inverter 26 may include an electronic oscillator, as will be understood by a person of skill in the art, which may create an approximately sinusoidal oscillation in the electrical power output signal.

The power inverter 26 may be a pure sine wave inverter, according to an embodiment of the present invention, capable of producing a substantially sinusoidal waveform in the outputted AC electrical power. A pure sine wave may be defined to include approximately less than five percent total harmonic distortion, as will be understood by a person of skill in the art. The power inverter 26 may additionally produce the pure sine wave, for example and without limitation, via a combination of switches and pulse width modulation.

The output of the power inverter 26 may be connected to a load 30. More specifically, as illustrated in the schematic 200, the output VAC_OUT of the power inverter 26 may be connected to the load 30 at a connection VL via the line VL_L. The output VAC_OUT of the power inverter 26 may also be connected to input VAC_IN of the charger 16 via the line VAC_L. Both the VAC_OUT and VAC_IN connections may also be connected to the load 30 at a connection VL via the line VAC_L, which may be further connected to the line VL_L.

The load 30 may include any device capable of consuming or generating electrical power. In one example, the load 30 may be an illuminating light or a refrigerator, consuming electrical power that may be drawn from the power inverter 26 included in the battery backup system 10 of the present invention. In another example, the load 30 may be a solar panel, windmill, hydroelectric generator, or electric power plant, generating electrical power that may provide electrical power to the charger 16 included in the battery backup system 10 of the present invention. The load 30 may additionally represent the electrical power grid of a home, community or other geographical region. A person of skill in the art will appreciate additional devices that may be defined as a load 30, which would be included within the scope and spirit of the present invention.

Referring now to FIG. 4, the controller 20 may be included as a component of the battery backup system 10. As previously stated, the controller 20 may include a microprocessor (“CPU”) 22, memory 24, and an I/O interface 25. The CPU 22 may be configured to receive one or more signals from additional components of the battery backup system 10, such as an indication of the feedback signal from the batteries included in the power cells 14 of the power cell array 12.

The CPU 22 may compute and perform calculations to the data received by the additional elements. As a non-limiting example, the CPU 22 may receive an indication of the level of charge included in the battery B1 of the first power cell 14. The CPU 22 may then analyze the level of charge to determine whether to operate the power cell 14 in the power state or charge state. The CPU 22 may generate a control signal, enabling or disabling switches SW1A, SW1B included in the power cell 14.

The controller 20 may also include a memory 24. The memory 24 may include volatile and non-volatile memory modules. The volatile memory module may include random access memory, which may temporarily store data and code being accessed by the CPU 22. The non-volatile memory module may include flash based memory, which may store the computerized program that may be operated on the CPU 22 and status logs that may be received from the power cells 14 during operation of the battery backup system 10.

Additionally, the memory 24 may include the computerized code used by the CPU 22 to control the operation of the battery backup system 10. The memory 24 may also store feedback information related to the operation of additional components included in the battery backup system 10. The memory 24 may also maintain historical information from the feedback received during operation. This historical information may be used by the controller 20, for example, to dynamically adjust the operation of the battery backup system 10, providing increased efficiency. The, historical information may additionally be accessed by a user for monitoring and analyzing the status of the battery backup system 10. In an embodiment of the present invention, the memory 24 may include an operating system, which may additionally include applications that may run from within the operating system, as would be appreciated by a person of skill in the art.

The controller 20 may also include an I/O interface 25. The I/O interface 25 may control the receipt and transmission of data between the controller 20 and additional components. Provided as a non-limiting example, the I/O interface 25 may receive a feedback signal from a voltage sensor, which may further include an indication of the voltage level of the battery B1 in a power cell 14. After the CPU 22 has analyzed the voltage level, the I/O interface 25 may transmit a control signal to one or more switches SW1A, SW1B. As discussed above, the control signal may direct the electrical power received from the charger 16 to charge the power cell 14 or draw electrical power from power cell 14 to drive the power inverter 26. Alternately, the I/O interface 25 may provide an interface for updating the memory 24 of the controller 20, for example, with firmware updates.

As the battery backup system 10 of the present invention may operate, it may advantageously control a power cell array 12 to deliver power to a load 30 upon demand, such as in emergency situations. The battery backup system 10 of the present invention may also intelligently draw electrical power from the power cells 14 included in the power cell array 12, advantageously operating the power cells 14 with high efficiency. Additionally, the battery backup system 10 of the present invention may draw power from a load 30 to charge the power cells 14 included in the power cell array 12.

Furthermore, the battery backup system 10 of the present invention may operate one or more power cell 14 in an idle state, wherein it may not receive or supply electrical power to or from additional components. By including an idle state, the power cells 14 of the battery backup system of the present invention may advantageously maintain an optimal level of charge in each included battery B1, thus extending the life of the battery.

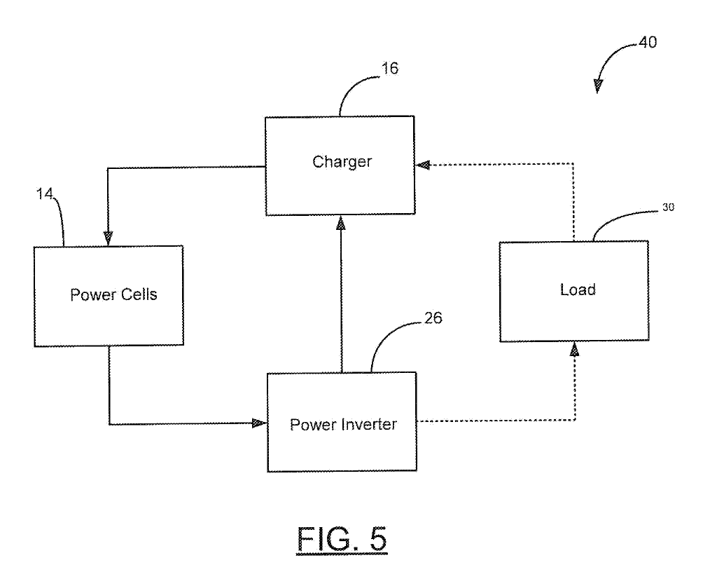

Referring now to FIG. 5, operation of the battery backup system 10 of the present invention will now be discussed generally. The operation of the illustrated components may be controlled by the controller 20, which has been discussed in greater detail above. As mentioned above, one or more power cells 14 may be included in the power cell array 12 to store and deliver electrical power. The power cell array 12 may be connected to a charger 16, which may supply electrical power to charge individual power cells 14 that are in a charge state. In the charge state, the electrical power stored in the battery B1 of a power cell 14 may be increased.

The power cell array 12 may also be connected to a power inverter 26. A power cell 14 operating in a power state may deliver DC electrical power to the power inverter 26, which may be inverted into AC electrical power. The power inverter 26 may then supply the AC electrical power to drive the charger 16 and/or a load 30. In the power state, the electrical power stored in the battery of a power cell 14 may be decreased.

As mentioned above, the charger 16 may use the electrical power received by the power inverter 26 to charge the power cells 14 of the power cell array 12 that are in a charge state. Additionally, the load 30 may provide electrical power to the charger 16, which may also be used to charge the power cells 14 of the power cell array 12 in a charge state.

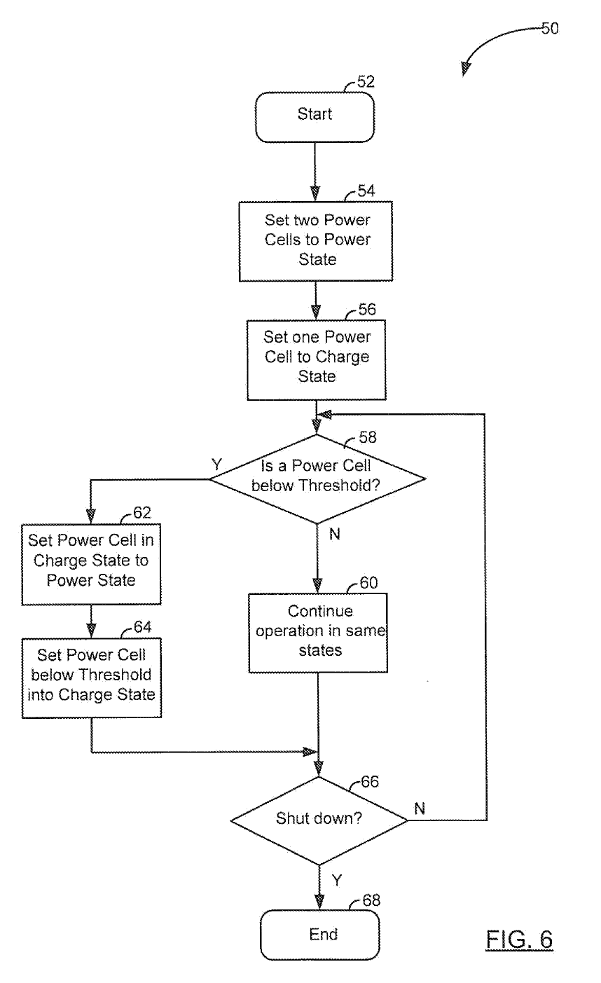

Referring now to, flowchart 50 of FIG. 6, an illustrative state control operation, which may be performed by the controller 20 to control the operation of the battery backup system 10 of the present invention, will now be discussed. A person of skill in the art will appreciate that the following illustrative operation is provided as a non-limiting example of one operation that may be used to battery backup system 10 of the present invention, as additional embodiments will be apparent to skilled artisans.

Additionally, the following example depicts battery backup system 10 that may include three power cells 14. This number of power cells 14 has been selected in the interested of clarity for describing the state control operation. A person of skill in the art will appreciate that any number of power cells 14 may be included in the battery backup system 10 of the present invention. Also, skilled artisans will appreciate that, although the power cells 14 may be preferably arranged in a 2:1 ratio of power cells 14 in the power state to the charge state, additional ratios are intended to be included within the scope of the present invention.

Starting at Block 52, the state control operation may begin by setting two power cells 14 to the power state (Block 54). While in the power state, electrical power may be drawn from the power cells 14 to drive the power inverter 26. The controller 20 may additionally set one power cell 14 to the charge state (Block 56).

In performing the, state control operation, the controller 20 may next determine whether a power cell 14 operating in the power state is below a threshold (Block 58). A threshold may be defined as the power cell operating at a minimum voltage level at which a battery included in a power cell 14 is desired to operate. The controller 20 may detect the voltage level of a battery B1 via the feedback signals previously discussed. An example threshold level may be set at a predetermined level, such as, for example, eighty percent. Alternately, an example threshold level may be calculated by the controller 20 and dynamically adjusted.

If it is determined at Block 58 that none of the power cells 14 include a battery B1 below the threshold, the controller 20 may continue operating the power cells 14 in their respective present states (Block 60). Conversely, if it is determined at Block 58 that one or more of the power cells 14 include one or more battery B1 operating below the threshold, the controller 20 may change the operational state of one or more of the power cells 14 from the charge state to the power state (Block 62).

The controller 20 may additionally set the power cell 14 below the threshold into the charge state (Block 62). While in the charge state, electrical power may be received to charge the power cells 14 from the charger 16. Preferably, the controller 20 may maintain a consistent ratio of power cells 14 in the power state to power cells 14 in the charge state.

The controller 20 may next determine whether a shutdown command has been received at Block 66. If it is determined that no shutdown command has been received, the state control operation will return to the decision of Block 58, wherein it may again determine whether a power cell 14 is below the threshold. If, however, it is determined at Block 66 that a shutdown command has been received, the state control operation may terminate (Block 70).

The battery backup system of the present invention may operate in a non-emergency mode or an emergency mode, according to an embodiment of the present invention. In the non-emergency mode, the battery backup system of the present invention may not provide electrical power to the load. Additionally, in the non-emergency mode of operation, the load may provide electrical power to the battery backup system of the present invention, as will be understood by skilled artisans. The electrical power provided by the load may be used to power the charger, which, in turn, may charge the power cells operating in the charge state.

In the emergency mode of operation, the battery backup system of the present invention may provide electrical power to the load. The electrical power may be drawn from the power cells by the power inverter, which may output an AC electrical power to drive the load.

The power cells 14 included in the power cell array 12 may be removable and/or replaceable. If one or more batteries B1 included in a power cell 14 may fail, the corresponding power cell 14 may be replaced. Alternately, the battery B1 included within the power cell 14 may be replaced upon failure, advantageously allowing continued use of the additional components of the power cell 14. The power cells 14 may also advantageously be “hot swapped,” or removed and replaced Without interrupting the operation of the battery backup system 10 of the present invention. By allowing “hot swapping,” the present invention may advantageously continue to provide electrical power upon demand without experiencing an interruption of service.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

What is claimed is:

1. A battery backup system comprising:
a power cell array including power cells and a charger to provide electrical power to be stored in the power Cells, each of the power cells comprising
a battery to store and discharge the electrical power,
a control input to control a state of the power cells, and
a feedback output to provide feedback signals;
a controller to control operation of the power cell array that includes a feedback input to receive the feedback signals relating to a status of each of the power cells, and a control output to control the state of the power cells; and
a power inverter to convert the electrical power discharged by the power cell array;
wherein the state of each of the power cells includes a power state defined by the power cells discharging the electrical power, and a charge state defined by the power cells receiving and storing the electrical power;
wherein the power cells are switchable between the power state and the charge state; and
wherein a ratio of the power cells in the power state to the power cells in the charging state is at least two to one.

2. A system according to claim 1 wherein the electrical power discharged by the power cell array drives a load.

3. A system according to claim 1 wherein the electrical power discharged by the power cell array drives the charger.

4. A system according to claim 1 wherein the power cell array outputs the electrical power as direct current electrical power, wherein the power inverter converts the direct current electrical power into alternating current electrical power.

5. A system according to claim 1 wherein the charger receives the electrical power as alternating current electrical power, wherein the charger converts the alternating current electrical power into direct current electrical power to store in the battery.

6. A system according to claim 1 wherein the controller operates each of the power cells in the power state until a threshold charge level is sensed; wherein the controller switches the power cells that are below the threshold charge level into the charge state; and wherein the controller correspondingly switches the power cells that are above the threshold charge level into the power state.

7. A system according to claim 1 wherein the power cells further include an idle state defined by substantially maintaining the electrical power in the power cells.

8. A system according to claim 2 wherein the system is operational in a non-emergency operation mode and an emergency operation mode, the non-emergency operation mode being defined as the load not drawing the electrical power from the power cell array, and the emergency operation mode being defined as the load drawing the electrical power from the power cell array.

9. A system according to claim 8 wherein the load provides the electrical power to the power cell array during the non-emergency operation.

10. A system according to claim 1 wherein the power inverter is a pure sine wave inverter; wherein the controller includes a microprocessor; and wherein the power cell further includes a servomechanism.

11. A system according to claim 2 wherein the load is selected from a group consisting of a solar panel, a windmill and a hydro-electric generator.

12. A battery backup system comprising:
a power cell array including power cells and a charger to provide electrical power to be stored in the power cells, each of the power cells comprising
a battery to store and discharge the electrical power,
a control input to control a state of the power cells, and
a feedback output to provide feedback signals;
a controller to, control operation of the power cell, array that includes a feedback input to receive the feedback signals relating to a status of each of the power cells and a control output to control the state of the power cells;
a power inverter to convert the electrical power discharged by the power cell array;
wherein the system is operational in a non-emergency operation mode and an emergency operation mode, the non-emergency operation mode being defined as a load not drawing the electrical power from the power cell array, and the emergency operation mode being defined as the load drawing the electrical power from the power cell array;
wherein the load provides the electrical power to the power cell array during the non-emergency operation;
wherein the power cell array outputs the electrical power as direct current electrical power, wherein the power inverter converts the direct current electrical power into alternating current electrical power to be used by the load; and
wherein the charger receives the electrical power as alternating current electrical power, wherein the charger converts the alternating current electrical power into direct current electrical power to store in the battery.

13. A system according to claim 12 wherein the state of each of the power cells includes a power state defined by the power cells discharging the electrical power, and a charge state defined by the power cells receiving and storing the electrical power;
wherein the controller operates each of the power cells in the power state until a threshold charge level is sensed, wherein the controller switches the power cells that are below the threshold charge level into the charge state;
wherein the controller correspondingly switches the power cells that are above the threshold charge level into the power state; and
wherein the power cells are switchable between the power state and the charge state.

14. A system according to claim 13 wherein a ratio of the power cells in the power state to the power cells in the charging state is two to one.

15. A system according to claim 12 wherein the power cells include an idle state defined by substantially maintaining the electrical power in the power cells.

16. A system according to claim 12 wherein the power inverter is a pure sine wave inverter; wherein the controller includes a microprocessor; and wherein the power cell further includes a servomechanism.

17. A system according to claim 12 wherein the load is selected from a group consisting of a solar panel, a windmill and a hydro-electric generator.

18. A method for storing and discharging electrical power in a battery backup system, the battery backup system comprising a power cell array, a controller, and a power inverter, the power cell, array including power cells, the method comprising:
controlling a state of each of the power cells by transmitting a control signal from the controller to each of the power cells, the state of each of the power cells including a power state and a charge state;
controlling each of the power cells in the power state to discharge the electrical power;
controlling each of the power cells in the charge state to receive and store the electrical power;
providing a feedback signal from each of the power cells to the controller relating to a status of each of the power cells;
transmitting the electrical power from the power cell array by
discharging the electrical power from each of the power cells in the power state to the power inverter, and
converting the electrical power discharged by the power cell array; and
storing the electrical power in the power cell array by
receiving the electrical power by the power cell; and
converting the electrical power received to store in the power cell array.

19. A method according to claim 18 further comprising operating the system in a non-emergency operation mode and an emergency operation mode, the non-emergency operation mode being defined as a load not drawing the electrical power from the power cell array, and the emergency operation mode being defined as the load drawing the electrical power from the power cell array.

20. A method according to claim 19 wherein the load provides the electrical power to the power cell array during the non-emergency operation.

21. A method according to claim 18 wherein the steps of controlling each of the power cells in the power state and controlling each of the power cells in the charge state further comprises
operating each of the power cells in the power state until a threshold charge level is sensed,
switching at least one of the power cells that are below the threshold charge level into the charge state, and
switching at the least one of the power cells that are above the threshold charge level into the power state.

22. A method according to claim 18 wherein a ratio of the power cells in the power state to the power cells in the charging state is two to one.

23. A method according to claim 18 wherein the step of transmitting the electrical power further includes
discharging the electrical power from the power cell array as direct current electrical power,
converting the direct current electrical power into alternating current electrical power, and
transmitting the alternating current electrical power to a load.

24. A method according to claim 18 wherein the step of storing the electrical power in the power cell array further includes
receiving the electrical power as alternating current electrical power,
converting the alternating current electrical power into direct current electrical power, and
storing the electrical power in the power cells.

25. A method according to claim 18 wherein the power cells further include an idle state defined by substantially maintaining the electrical power in-the power cells.

26. A method according to claim 18 wherein the power inverter is a pure sine wave inverter, wherein the controller is a microprocessor and wherein the switch is a servomechanism.

27. A method according to claim 19 wherein the load is selected from a group consisting of a solar panel, a windmill and a hydro-electric generator.
